(19) United States
(12) Patent Application Publication
(10) Pub. No.: US 2015/0085619 A1
(43) Pub. Date: Mar. 26, 2015

(54) DEVICE AND METHOD FOR OUTPUTTING SOUND WAVE, AND MOBILE DEVICE AND METHOD FOR GENERATING CONTROL INFORMATION CORRESPONDING TO THE SOUND WAVE

(71) Applicant: Powervoice Co., Ltd., Bucheon-si (KR)

(72) Inventors: Hee Suk JEONG, Gimpo-si (KR); Se Hun CHIN, Incheon (KR); Hyung Yup LEE, Yongin-si (KR); Jong Sang TACK, Chuncheon-si (KR)

(21) Appl. No.: 14/494,694

(22) Filed: Sep. 24, 2014

(30) Foreign Application Priority Data
Sep. 24, 2013 (KR) 10-2013-0113500

(51) Int. Cl. G08C 23/02

(52) U.S. Cl. CPC G08C 23/02; G08C 2201/93; G08C 2201/70; G08C 2201/31
USPC 367/198; 367/199

(57) ABSTRACT

A device includes a sound wave reception unit that receives a sound wave output from a mobile device, through a sound wave reception device; a control information acquisition unit that acquires control information associated with operation of the device from the received sound wave; and an operation performance unit that performs the operation based on the control information. The control information acquisition unit determines a frequency band, to which at least one frequency identified from a certain frame within the received sound wave corresponds, from an audible sound wave frequency band and a non-audible sound wave frequency band, and partial information based on the frequency band and the at least one identified frequency, and acquires control information corresponding to the received sound wave based on each of the determined partial information.

### CROSS-REFERENCE TO RELATED APPLICATION

This application claims the benefit of Korean Patent Application No. 10-2013-0113500 filed on Sep. 24, 2013, the disclosures of which are incorporated herein by reference.

### TECHNICAL FIELD

The embodiments described herein pertain generally to a device and a method for outputting a sound wave, and a mobile device and a method for generating control information corresponding to the sound wave.

### BACKGROUND

Smart household appliances having the Internet access function such as refrigerators, washing machines, ovens, cleaners, air conditioners and TVs have recently come into the market and are becoming gradually popular. When a new recipe or washing method is added, the smart household appliances can be updated online to furnish the corresponding function, and the operation state of the smart household appliances can be remotely identified from the outside. For example, there may be a refrigerator having functions for shopping through the Internet and management of groceries and other functions, in addition to the simple cooling or freezing function.

Meanwhile, such smart household appliances necessarily require Internet access and access to an access point (AP) like a wireless sharer or others on a home network to be incorporated with other devices. However, current smart household appliances are disadvantageous in that due to their restricted functions for limitation in screens and input devices, specification of hardware and software and other reasons, data input for network setting is complicated and cumbersome. Thus, a method capable of controlling operation of smart household appliances without access to a wireless sharer on a home network is demanded. Korean Patent Application Publication No. 2006-0089854 describes configuration of a system, which controls operation of household appliances by using a home gateway connected to the external Internet.

### SUMMARY

In view of the foregoing, example embodiments enable incorporation between home appliances and a mobile device without requiring separate wireless communication access. Example embodiments provide a system, a device and a method, by which a mobile device can easily control operation of home appliances by using a sound wave, the status and breakdown of home appliances are effectively delivered to a mobile device, and rapid measures can be taken. Example embodiments provide a function equal to smart home appliances through home appliances equipped with no communication module as well as home appliances in areas under an inferior communication environment. However, the problems sought to be solved by the present disclosure are not limited to the above description, and other problems can be clearly understood by those skilled in the art from the following description.

In one example embodiment, a device includes: a sound wave reception unit that receives a sound wave output from a mobile device, through a sound wave reception device; a control information acquisition unit that acquires control information associated with operation of the device from the received sound wave; and an operation performance unit that performs the operation based on the control information. The control information acquisition unit determines a frequency band, to which at least one frequency identified from a certain frame within the received sound wave corresponds, from an audible sound wave frequency band and a non-audible sound wave frequency band, and partial information based on the frequency band and the at least one identified frequency, and acquires control information corresponding to the received sound wave based on each of the determined partial information.

In another example embodiment, a method for controlling a device includes: receiving a sound wave output from a mobile device through a sound wave reception device; acquiring control information associated with operation of the device from the received sound wave; and performing the operation based on the control information. The acquiring of the control information comprises: determining a frequency band, to which at least one frequency identified from a certain frame within the received sound wave corresponds, from an audible sound wave frequency band and a non-audible sound wave frequency band, and partial information based on the frequency band and the at least one identified frequency; and acquiring control information corresponding to the received sound wave based on each of the determined partial information.

In still another example embodiment, a mobile device, includes: a sound wave reception unit that receives a sound wave output from a device, through a sound wave reception device; a status information acquisition unit that acquires status information of the device by using the sound wave; a control information generation unit that generates control information for the device based on the status information; a sound wave data generation unit that generates sound wave data corresponding to the control information; and an output unit that outputs a sound wave corresponding to the generated sound wave data through a sound wave output device. The sound wave data generation unit generates a plurality of partial information corresponding to the control information, determines a frequency band, which corresponds to each of the plurality of the partial information, from an audible sound wave frequency band and a non-audible sound wave frequency band, determines at least one frequency corresponding to each of the plurality of the partial information within the determined frequency band, generates a sound signal corresponding to the determined frequency for each of the plurality of the partial information, and generates the sound wave data by combining the sound signals with one another.

In accordance with the example embodiments, it is possible to enable incorporation and bi-directional control between home appliances and a mobile device without requiring separate wireless communication access. It is possible to provide a system, a device and a method, by which the status and breakdown of home appliances are effectively delivered from the home appliances to a mobile device by using a sound wave, and rapid measures can be taken. It is possible to provide a function equal to smart home appliances through home appliances equipped with no communication module as well as home appliances in areas under an inferior communication environment. It is possible to provide smart appliances, which can be controlled by recognizing voice corresponding to an audible sound wave frequency band together with a sound wave (sound code) corresponding to an audible sound wave frequency band or a non-audible sound wave frequency band.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 is a configuration view of a smart diagnosis system in accordance with an example embodiment.

FIG. 2 is a configuration view of a device in accordance with an example embodiment.

FIG. 3 is a configuration view of a sound wave data generation unit 13 in accordance with an example embodiment.

FIG. 4 shows an example for mapping a frequency to partial information.

FIG. 5 is a configuration view of a control information acquisition unit 17 in accordance with an example embodiment.

FIG. 6 is an operation flow chart showing an example for operation of a device 10, a mobile device 20 and a control server 30.

FIG. 7 depicts an example for operation of an operation performance unit 11.

FIG. 8a to FIG. 8e depict an example for operation of a position information generation unit 18.

FIG. 9 is a configuration view of a mobile device 20 in accordance with an example embodiment.

FIG. 10 is an operation flow chart showing a sound wave outputting method in accordance with an example embodiment.

FIG. 11 is an operation flow chart showing another control information outputting method in accordance with an example embodiment.

### DETAILED DESCRIPTION

Hereinafter, example embodiments will be described in detail with reference to the accompanying drawings so that inventive concept may be readily implemented by those skilled in the art. However, it is to be noted that the present disclosure is not limited to the example embodiments but can be realized in various other ways. In the drawings, certain parts not directly relevant to the description are omitted to enhance the clarity of the drawings, and like reference numerals denote like parts throughout the whole document.

Throughout the whole document, the terms “connected to” or “coupled to” are used to designate a connection or coupling of one element to another element and include both a case where an element is “directly connected or coupled to” another element and a case where an element is “electronically connected or coupled to” another element via still another element. In addition, the terms “comprises or includes” and “comprising or including” used in this document mean that other components may be further included, and not that other components are excluded, unless otherwise described herein, and should be construed as meaning that the possibility of presence or addition of other characteristics, numerals, steps, operations, components, parts or combinations thereof is not preliminarily excluded.

Throughout the whole document, the term “unit” includes a unit realized by hardware, a unit realized by software, and a unit realized by both hardware and software. In addition, one unit may be realized by using two (2) or more hardware systems, and two (2) or more units may be realized by one hardware system.

Throughout the whole document, part of operation or functions that are described to be performed by a terminal or a device may be performed by a server connected to the corresponding terminal or device. Likewise, part of operation or functions that are described to be performed by a server may also be performed by a terminal or device connected to the corresponding server.

Example embodiments to be described hereinafter are detailed descriptions of the present disclosure to facilitate understanding of the present disclosure and are not intended to limit the scope of the present disclosure. Thus, a subject matter having the same scope and performing the same function as those of the present disclosure also fall within the protection scope of the present disclosure.

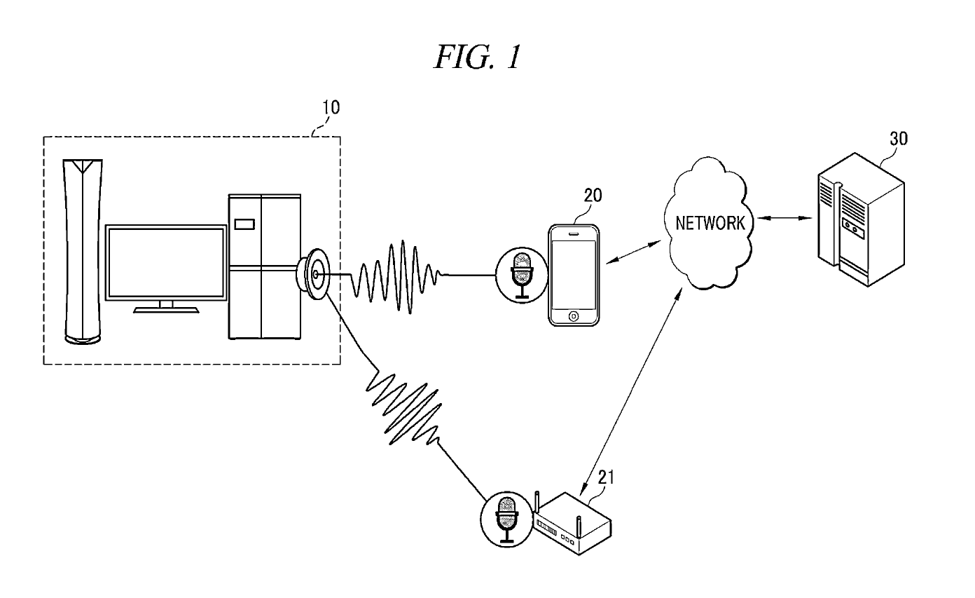

FIG. 1 is a configuration view of a smart diagnosis system in accordance with an example embodiment. With reference to FIG. 1, the smart diagnosis system includes a device 10, a mobile device 20 and a control server 30. In addition, as illustrated in FIG. 1, the smart diagnosis system may further include a network device 21. Since the smart diagnosis system of FIG. 1 is merely an example embodiment of the present disclosure, the present disclosure is not construed narrowly by FIG. 1, and various applications based on FIG. 1 are possible.

The device 10 receives a sound wave output from the mobile device 20 through a sound wave reception device, acquires control information associated with operation of the device 10 from the received sound wave, and performs the operation based on the control information. In this case, the device 10 determines a frequency band, to which at least one frequency identified from a certain frame within the received sound wave corresponds, from an audible sound wave frequency band and a non-audible sound wave frequency band, and partial information based on the frequency band and the at least one identified frequency, and acquires control information corresponding to the received sound wave based on each of the determined partial information. For example, the device 10 may notify the mobile device 20 of status information presenting that an error has occurred in the operation of the device 10, receive a sound wave output from the mobile device 20 in response, and temporarily stops its operation based on control information acquired from the received sound wave.

While performing the operation of the device 10, the device 10 generates its status information in association with the operation, generates sound wave data corresponding to the generated status information, and outputs a sound wave corresponding to the generated sound wave data. The device 10 receives the sound wave output from the mobile device 20, acquires control information from the received sound wave, and performs the operation based on the control information. In this case, the control information may be generated in the mobile device 20 based on the status information, and the status information may be at least one of current status information and breakdown diagnosis information of the device 10. An example for the current status includes on/off, the power use state, operation time and others of the device 10, and an example for the breakdown diagnosis information includes error symptom occurrence information, an error code, broken part information and so on.

An example for the device 10 may be a smart home appliance. In general, the smart home appliance is a home appliance, which can be controlled to automatically accomplish its optimum performance, and may be, but is not limited thereto, a refrigerator, a washing machine, an air conditioner, an oven, a microwave, a cleaner, an electric fan and so on. In addition, the device 10 is not limited to the air conditioner, the TV and the refrigerator illustrated in FIG. 1.

The mobile device 20 receives the sound wave output from the device 10 through a sound wave reception device, acquires status information by using the sound wave, generates control information about the device 10 based on the status information, generates sound wave data corresponding to the control information, and outputs a sound wave corresponding to the generated sound wave data through a sound wave output device.

Specifically, the mobile device 20 may generate the sound wave data, by generating a multiple number of partial information corresponding to the control information, determining a frequency band, which corresponds to each of the multiple number of the partial information, from an audible sound wave frequency band and a non-audible sound wave frequency band, determining at least one frequency corresponding to each of the multiple number of the partial information within the determined frequency band, generating a sound signal corresponding to the determined frequency for each of the multiple number of the generated partial information, and combining the sound signals.

The mobile device 20 may transmit the status information of the device 10 to the control server 30, and receive control information associated with the device 10 or specific information necessary for the control information from the control server 30. In this case, the mobile device 20 may generate control information for the device 10 by using the received control information or specific information.

An example for the mobile device 10 may be a mobile device that can access a remote server through a network. Here, the mobile device is a mobile communication device assuring portability and mobility and may include, for example, any types of handheld-based wireless communication devices such as personal communication systems (PCSs), global systems for mobile communication (GSM), personal digital cellulars (PDCs), personal handyphone systems (PHSs), personal digital assistants (PDAs), international mobile telecommunication (IMT)-2000, code division multiple access (CDMA)-2000, W-code division multiple access (W-CDMA), wireless broadband Internet (WiBro) terminals and smart phones, smart pads, tablet PCs and so on.

The control server 30 is incorporated with the mobile device 20 through a network. For example, when the control server 30 receives the status information of the device 10 from the mobile device 20 through a network, it delivers control information associated with the device 10 to the mobile device 20 in response to the status information. Such a control server 30 may mean a management server or a breakdown diagnosis server.

The network means a connection structure capable of enabling information exchange between nodes such as terminals and servers, and examples for the network include a 3GPP (3rd Generation Partnership Project) network, a long term evolution (LTE) network, a world interoperability for microwave access (WIMAX) network, the Internet, a local area network (LAN), a wireless local area network (Wireless LAN), a wide area network (WAN), a personal area network (PAN), a Bluetooth network, a satellite broadcasting network, an analogue broadcasting network, and a digital multimedia broadcasting (DMB), but not limited thereto.

The network device 21 may receive the sound wave output from the device 10 through the sound wave reception device, acquire status information by using the sound wave, generate control information about the device 10 based on the status information, and output the generated control information. In this case, the network device 21 may output the sound wave corresponding to the control information through the sound wave output device. The network device 21 is a relay device, which is connected to a network to enable other devices located within a specific distance based on the relay device to be connected to the network, and an example for the network device 21 includes a switch, a gateway, a router, and an access point forming a short-distance wireless network.

The network device 21 may also transmit the status information of the device 10 to the control server 30, and receive control information associated with the device 10 or specific information necessary for the control information from the control server 30. In this case, the network device 21 may generate control information for the device 10 by using the received control information or specific information. The operation of the mobile device 20 will be mostly described through the drawings, but since the network device 21 can also perform all operations corresponding to the operation of the mobile device 20, all descriptions of the mobile device 20 to be provided hereinafter are identically applied to the network device 21.

Operation of each of the components in FIG. 1 will be described more in detail by using the drawings.

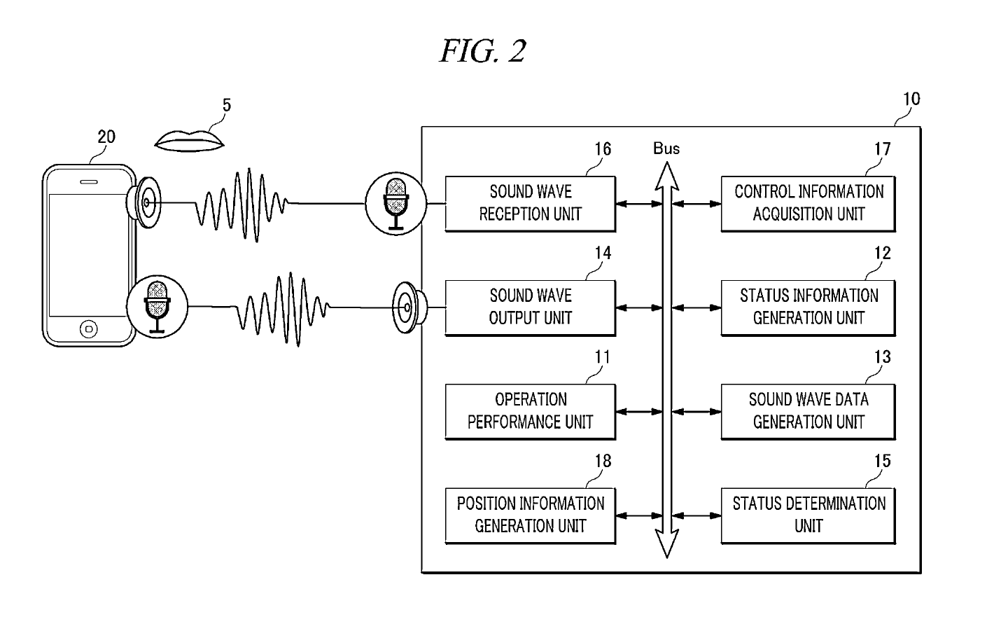

FIG. 2 is a configuration view of a device in accordance with an example embodiment. With reference to FIG. 2, the device 10 includes an operation performance unit 11, a status information generation unit 12, a sound wave data generation unit 13, a sound wave output unit 14, a status determination unit 15, a sound wave reception unit 16, a control information acquisition unit 17, and a position information generation unit 18. However, the device 10 illustrated in FIG. 2 is merely an example embodiment of the present disclosure, and various modifications based on the components illustrated in FIG. 2 are possible. For example, the device 10 may further include a user interface, a display, a power device and others.

The operation performance unit 11 performs operation based on control information associated with the operation of the device 10. In this case, the control information is acquired by the control information acquisition unit 17, which will be described later, and the operation performance unit 11 performs the operation through at least one power device included in the device 10. For example, if the device 11 is a refrigerator, the operation performance unit 11 may perform operation for circulation of a refrigerant through a power device included in the refrigerator. As another example, if the device 11 is a cleaner, the operation performance unit 11 may perform operation for moving the cleaner through the power device. As another example, if the device 11 is an electric fan, the operation performance unit 11 may perform operation for rotating fans of the electric fan through the power device.

The status information generation unit 12 generates status information of the device 10 in association with the operation. In this case, the status information is at least one of current status information or breakdown diagnosis information of the device 10, and an example for the current status includes on/off, the power use state, operation time and others of the device 10, and an example for the breakdown diagnosis information includes error symptom occurrence information, an error code, broken part information and others.

When an error symptom occurs in association with the operation of the device 19, the status information generation unit 12 may generate status information corresponding to the occurrence of the error symptom. For example, if the device 10 is a refrigerator, and the operation of the device 10 is stopped, the status information generation unit 12 may generate status information presenting that the operation of the device 10 has been stopped. As another example, if the device 10 is a washing machine, and a specific error code occurs in the washing machine, the status information generation unit 12 may generate status information corresponding to the error code.

The sound wave data generation unit 13 generates sound wave data corresponding to the status information. Specifically, the sound wave data generation unit 13 may generate a multiple number of partial information corresponding to the status information, determine a multiple number of frequencies corresponding to the multiple number of the generated partial information, and combine sound signals corresponding to the multiple number of the respective determined frequencies with one another depending on a preset time interval to generate sound wave data corresponding to the status information.

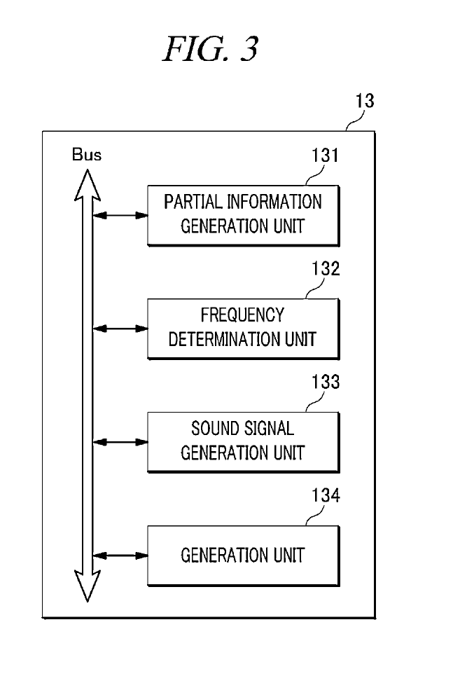

FIG. 3 is a configuration view of the sound wave data generation unit 13 in accordance with an example embodiment. With reference to FIG. 3, the sound wave data generation unit 13 includes a partial information generation unit 131, a frequency determination unit 132, a sound signal generation unit 133 and a generation unit 134. However, according to various example embodiments of the present disclosure, FIG. 3 is merely an example embodiment of the present disclosure, and the configuration of the sound wave data generation unit 13 may be different from that in FIG. 3.

The partial information generation unit 131 generates a multiple number of partial information corresponding to the status information. In this case, an example for the partial information is at least one of characters such as “ [symbol] ” and “a,” numerals such as “1” and “2,” and signs. In addition, the characters may be a broad concept including numerals and signs.

The frequency determination unit 132 determines a frequency band, which corresponds to each of the multiple number of the generated partial information, from an audible sound wave frequency band and a non-audible sound wave frequency band, and determines a frequency corresponding to each of the multiple number of the partial information within the determined frequency band.

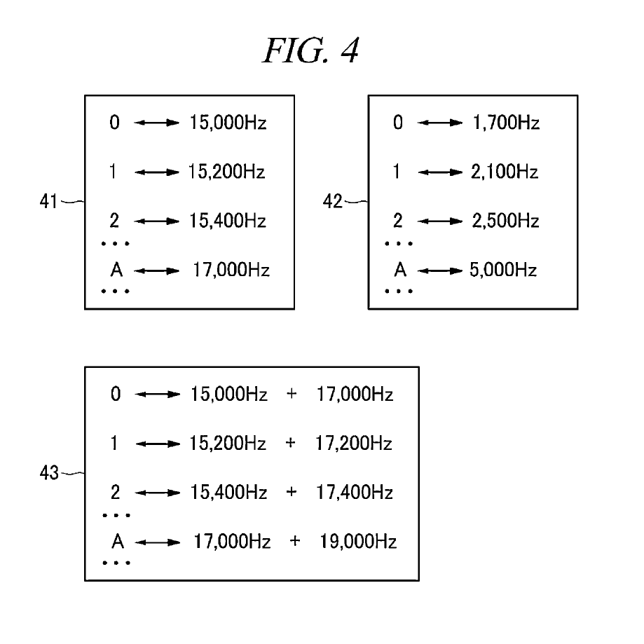

FIG. 4 depicts an example for mapping a frequency to partial information.

For example, the frequency determination unit 132 divides a total bandwidth of 5000 Hz between 15000 Hz and 20000 Hz for a non-audible sound wave frequency band by a unit of at least 200 Hz, so as to discriminate twenty-five (25) frequencies, and then, determines each of the 25 discriminated frequencies to be a frequency corresponding to each of 25 partial information.

To describe an example with reference to the reference number 41 in FIG. 4 (using a non-audible sound wave frequency band), the frequency determination unit 132 may map partial information “0” to the frequency of 15000 Hz, partial information “1” to the frequency of 15200 Hz, partial information “2” to the frequency of 15400 Hz, and partial information “A” to the frequency of 17000 Hz. In accordance with an example embodiment, the frequency determination unit 132 may map a frequency band to each of the partial information. For example, the frequency determination unit 132 may map the partial information “0” to the frequency ranging from 15000 Hz to 15200 Hz, the partial information “1” to the frequency ranging from 15200 Hz to 15400 Hz, the partial information “2” to the frequency ranging from 15400 Hz to 15600 Hz, and the partial information “A” to the frequency ranging from 17000 Hz to 17200 Hz.

In addition, to describe an example with reference to the reference numeral 42 in FIG. 4 (using an audible sound wave frequency band), the frequency determination unit 132 may map the partial information “0” to the frequency of 1700 Hz, the partial information “1” to the frequency of 2100 Hz, the partial information “2” to the frequency of 2500 Hz, and the partial information “A” to the frequency of 5000 Hz. As described above, identical partial information may be mapped to different frequencies depending on which frequency band is used.

This frequency mapping information may be identically stored in advance in each of the device 10 controlled by a type of a code book and the mobile device 20.

The sound signal generation unit 133 generates a multiple number of sound signals corresponding to the multiple number of the frequencies, respectively. For example, the sound signal generation unit 133 may generate a first sound signal corresponding to a first frequency, and a second sound signal corresponding to a second frequency.

The sound signal generation unit 133 may generate, as sound signals, sinusoidal sound wave signals, which have a frequency as a center (or basic) or carrier frequency. For example, the sound signal generation unit 133 may generate sinusoidal sound wave signals having a frequency of 15000 Hz as their basic frequencies.

The generation unit 134 generates sound data corresponding to the status information by combining or arranging the multiple number of the sound signals with one another depending on a preset time interval. Specifically, the sound code generation unit 134 may generate a sound code corresponding to the information, by combining or arranging the multiple number of the sound signals depending on a time interval. In this case, the sound signals arranged depending on a time interval may be configured as the respective frames of the sound code.

The sound code may include a header, a body and a tail. In this case, the body may include the multiple number of the sound signals, the header may include an additional sound signal (or an additional sound code) corresponding to additional information such as identification information of the encoding apparatus and identification information of the decoding apparatus, and the tail may include an error correction sound signal (or an error correction sound code) corresponding to an error correction code like cyclic redundancy check (CRC).

In accordance with an example embodiment, the frequency determination unit 132 may determine first and second frequencies corresponding to first partial information, and the sound signal generation unit 133 may generate a first sound signal corresponding to first and second frequency bands. Thus, the frequency determination unit 132 may allocate or map two (2) or more frequencies to one partial information, and the sound signal generation unit 133 may generate an individual sound signal based on the two (2) or more frequencies.

In accordance with an example embodiment, the first and second sinusoidal sound wave signals are discrete signal samples, and the sound signal generation unit 133 may generate a first analogue sound signal corresponding to the first sinusoidal sound wave signal and a second analogue sound signal corresponding to the second sinusoidal sound wave signal by using the codec, and add the first and second analogue sound signals to each other, so as to generate the first sound signal.

In accordance with an example embodiment, the frequency determination unit 132 may determine different frequencies for the first and second partial information, which are identical to each other in content. For example, when an identical character continues, like the case where first partial information is “1,” and second partial information is “1,” the frequency determination unit 132 may determine a frequency of the first partial information to be 15000 Hz, and a frequency of the second partial information to be 19000 Hz.

In accordance with an example embodiment, the sound wave data generation unit 13 may discriminate an audible sound wave frequency band corresponding to voice and a non-audible sound wave frequency band corresponding to a sound code, and generate and output voice data and sound wave data by the discriminated frequency bands. The audible sound wave frequency band may be a frequency band within a range of from 100 Hz or more to 8000 Hz or less, and the non-audible sound wave frequency band may be a frequency band within a range of from 15000 Hz or more to 24000 Hz or less.

Returning to FIG. 2, the sound wave output unit 14 outputs a sound wave corresponding to the sound wave data generated in the sound wave data generation unit 13 through a sound wave output device. In this case, an example for the sound wave output device is a speaker device, but not limited thereto. The output sound wave is input into the mobile device 20 or the network device 21.

In accordance with an example embodiment, the status determination unit 15 may determine the status of the device 10. In this case, the status information generation unit 12 may generate status information of the device 10 depending on the result of the status determination. For example, the status determination unit 15 may periodically determine the status of the device 10 at a five (5)-minute interval, and the status information generation unit 12 may generate status information of the device 10 when error symptom of the device 10 occurs, as a result of the determination by the status determination unit 15.

In accordance with an example embodiment, the sound wave reception unit 16 receives the sound wave output from the mobile device 20 through a sound wave reception device. This sound wave will be referred-to as the “received sound wave” for convenience in descriptions to be provided hereinafter. In addition, an example for the sound wave reception device is a microphone, but not limited thereto. In addition, the received sound wave includes a response to the sound wave output by the sound wave output unit 14, and an example for the response may be control information.

The control information acquisition unit 17 acquires control information associated with the operation of the device 10 from the received sound wave. The control information acquisition unit 17 determines a frequency band, to which at least one frequency identified from a certain frame within the received sound wave corresponds, from an audible sound wave frequency and a non-audible sound wave frequency band, and partial information based on the frequency band and the at least one identified frequency, and acquires control information corresponding to the received sound wave based on each of the determined partial information.

Specifically, the control information acquisition unit 17 may divide the received sound wave into a multiple number of frames depending on a preset time interval, identify at least one frequency corresponding to each of the multiple number of the frames through frequency analysis for each of the multiple number of the frames, and determine a multiple number of partial information based on a frequency band, to which each of the identified frequencies corresponds, and each of the identified frequencies, and generate control information corresponding to the received sound wave based on the determined partial information.

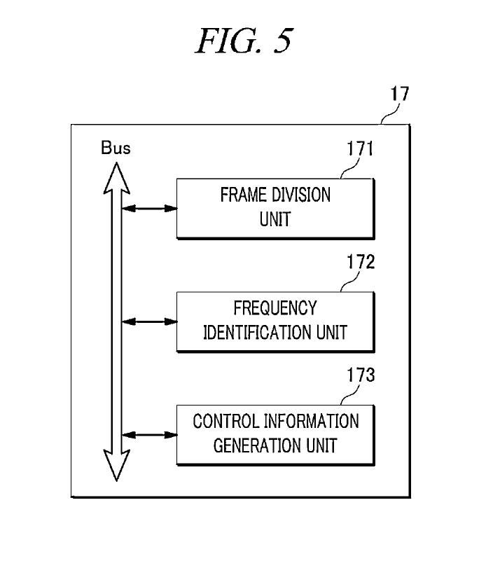

FIG. 5 is a configuration view of the control information acquisition unit 17 in accordance with an example embodiment. With reference to FIG. 5, the control information acquisition unit 17 includes a frame division unit 171, a frequency identification unit 172, and a control information generation unit 173. However, FIG. 5 is merely an example embodiment of the present disclosure, and in accordance with various example embodiments of the present disclosure, the control information acquisition unit 17 may be differently configured from FIG. 5.

The frame division unit 171 divides the received sound wave depending on a preset time interval to generate a multiple number of frames. For example, the frame division unit 171 divides the received sound wave into a multiple number of frames depending on a one (1)-second time interval. In this case, if the received sound wave is a sound wave lasting for ten (10) seconds, the received sound wave may be divided into ten (10) frames.

The frequency identification unit 172 identifies a frequency corresponding to each of the multiple number of the frames through frequency analysis for each of the multiple number of the frames. In this case, each of the multiple number of the frames includes a sound signal of a preset frequency, and the frequency corresponding to each of the multiple number of the frames may mean a frequency of the sound signal. In general, the multiple number of the frequencies may be selected within a range of from 15000 Hz or more to 24000 Hz or less corresponding to a non-audible sound wave frequency band, and an interval of the multiple number of the frequencies may be at least 200 Hz. In addition, the multiple number of the frequencies may be selected within a range of from 100 Hz or more to 8000 Hz or less corresponding to an audible sound wave frequency band. In addition, the frequency identification unit 172 may identify a frequency by analyzing a frequency peak for each of the multiple number of the frames.

The frequency identification unit 172 may identify, for example, 15000 Hz, which is a frequency of a sound signal included in a first frame among the multiple number of the frames, and 17000 Hz, which is a frequency of a sound signal included in a second frame. In this regard, the mobile device 20 may divide a total bandwidth of 5000 Hz between 15000 Hz to 20000 Hz for a non-audible sound wave band frequency by a unit of 200 Hz, so as to discriminate 25 frequencies, determine the discriminated 25 frequencies to be frequencies corresponding to 25 partial information, respectively, and generate sound signals corresponding to the determined frequencies to arrange the sound signals in the respective frames of the sound code.

The frequency identification unit 172 identifies a frequency through frequency analysis. To this end, the frequency identification unit 172 may identify a frequency by using a frequency transformation technique and an inverse frequency transformation technique for the multiple number of the frames or the sound signal of each of the multiple number of the frames. An example for the frequency conversion technique is fast fourier transform (FFT), and an example for the inverse frequency conversion technique is inverse fast fourier transform (IFFT)

The sound signals may be sinusoidal sound wave signals having a preset frequency as their center (or basic) or carrier frequencies. For example, a first sound signal is a sinusoidal sound wave signal having a frequency of 15000 Hz as a basic frequency. In accordance with an example embodiment, the sinusoidal sound wave signals are discrete signal samples, and the sound signals may be analogue sound signals transformed from the sinusoidal sound wave signals through the codec.

The control information generation unit 173 generates control information corresponding to the sound wave based on the multiple number of the partial information corresponding to the respective identified frequencies. In this case, an example for the partial information is at least one of characters such as “ [symbol] ” and “a,” numerals such as “1” and “2,” and signs. In addition, the characters may be a broad concept including numerals and signs.

For example, if the sound code consists of three (3) frames, a frequency of a first frame is 15000 Hz, a frequency of a second frame is 15200 Hz, and a frequency of a third frame is 17000 Hz, the control information generation unit 173 generates partial information “0” corresponding to 15000 Hz, partial information “1” corresponding to 15200 Hz, and partial information “A” corresponding to 17000 Hz.

The control information generation unit 173 generates control information corresponding to the received sound wave based on the multiple number of the partial information. For example, if partial information of the first frame is “0,” partial information of the second frame is “1,” and partial information of the third frame is “A,” the control information generation unit 173 may combine the partial information with one another to decode or generate “01A,” which is control information corresponding to the sound code.

The received sound wave may include a header, a body and a tail. In this case, the body may include the multiple number of the sound signals, the header may include an additional sound signal (or an additional sound code) corresponding to additional information such as identification information of the mobile device 20 and identification information of the device 10, and the tail may include an error correction sound signal (or an error correction sound code) corresponding to an error correction code like cyclic redundancy check (CRC). The control information generation unit 173 may decode or generate information or partial information based on the header, the body and the tail included in the received sound wave.

In accordance with an example embodiment, the frequency identification unit 172 may identify first and second frequencies from the first frame, and the control information generation unit 173 may generate first partial information based on the first and second frequencies. Thus, the frequency identification unit 172 may identify two (2) or more frequencies from one frame, and the control information generation unit 173 may generate single partial information corresponding to the two (2) or more frequencies.

That is, if sound signals are allocated such that two (2) frequencies are identified from one frame, 600 information representations, which are obtained by multiplying 25 and 24, are possible in theory. In this case, even if closely related frequencies are excluded in consideration of discrimination of frequencies, at least 500 stable information representations, which are obtained by multiplying 25 and 20, are possible.

To describe an example with reference to the reference numeral of 43 in FIG. 4, the frequency identification unit 172 may identify each of a first frequency of 15000 Hz and a second frequency of 17000 Hz from the first frame, and the control information generation unit 173 may generate first partial information “0” based on the first and second frequencies. In this case, a sound signal of the first frame may be formed of a combination of first and second analogue sound signals, the first analogue sound signal may be one transformed from a first sinusoidal sound wave signal having the first frequency as a center frequency through the codec, and the second analogue sound signal may be one transformed from a second sinusoidal sound wave signal having the second frequency as a center frequency through the codec.

In accordance with an example embodiment, the frequency identification unit 172 may identify a frequency based on an energy value corresponding to each of the multiple number of the frames. In general, when a sound wave is output at a close distance within 1 m, a frequency spectra scope of the sound wave received in the device 10 has a sharp shape. That is, as a signal to noise ratio (SNR) of the received sound wave is excellent, the recognition rate of the decoding apparatus 20 is high. However, when a sound wave is output in a long distance of 5 m or more, the SNR of the received sound wave is decreased, so that the device 10 cannot easily perform the recognition. As a solution to the problem, recognition performance in a long distance environment can be improved by performing feature parameter extraction using linearity of a spectra scope of a sinusoidal tone of the sound wave. An example for the feature parameter extraction may improve the recognition performance by squaring an energy value of the received sound wave by the multiple number of the frames.

For example, when a spectrum log energy value of a particular frequency desired to be recognized is 10, and a spectrum log energy value of noise is 5, the SNR is 5 dB, which is obtained by deducting 5 from 10. However, if the frequency identification unit 23 squares the energy value of the sound wave by frames, the SNR in a specific frame becomes 10 dB (10=(10+10)−(5+5)). The increase of the SNR from 5 dB to 10 dB means that an identification rate of the sound signal or code has significantly increased, compared to noise.

In accordance with an example embodiment, the control information generation unit 173 may identically interpret partial information of the frequency of the first frame and partial information of the frequency of the second frame in a certain circumstance, even when the frequency of the first frame and the frequency of the second frame are different from each other.

In general, various reverberations may exist depending on an interior structure in an indoor recognition environment. As a frequency component by such reverberations significantly affects a frequency component of a next signal sequence (or partial information), it may be a cause for occurrence of errors at the decoding time. Especially, when identical partial information continues, a reverberant component seriously affects the next partial information. As a solution to the problem, when identical partial information continues, the mobile device 20 and the device 10 may determine a frequency band of the second partial information to be a preset specific frequency, and thereby, reducing errors resulting from the reverberant component.

For example, if a frequency of the first frame is identified as 15000 Hz, and a frequency of the second frame is identified as 19000 Hz, even though the frequency of the second frame corresponds to partial data “α,” the control information generation unit 173 does not interpret the frequency of the second frame as “α,” and may interpret the frequency of the second frame as partial information “1” corresponding to the frequency of 15000 Hz of the first frame. Finally, the control information generation unit 173 may determine information consisting of the first and second frames to be “11.” In this case, “α” may be preset partial information, which is used when continued partial information such as “1” and “1,” “2” and “2,” and “A” and “A” occurs.

In accordance with an example embodiment, information may be generated even in consideration of voice recognition. The sound wave reception unit 16 may receive a sound code output from the mobile device 20 and voice of a user 5, and generate information based on voice recognition for the voice and recognition of the sound code. In this case, the frequency of the sound code corresponding to the audible sound wave frequency band and the frequency of the voice corresponding to the audible sound wave frequency band may be selected within a range of from 100 Hz or more to 8000 Hz or less, and the frequency of the sound code corresponding to the non-audible sound wave frequency band may be selected within a range of from 15000 Hz or more to 24000 Hz or less.

The control information generation unit 173 may recognize the voice of the user 5 through the voice recognition to generate first information corresponding to the voice, generate second information corresponding to the sound code, and generate information by using the first and second information. For example, the control information generation unit 173 may generate information by decoding the second information by using the first information, or combining the first and second information with each other.

For example, the control information generation unit 173 may perform the voice recognition for the voice corresponding to the audible sound wave frequency band, and decode the sound code corresponding to the non-audible sound wave frequency band. The control information generation unit 173 may generate information (control information) by using the result of the voice recognition and the decoding result.

It is possible to mutually combine, recognize and operate the voice corresponding to an audible sound wave frequency band and the sound code corresponding to an audible or non-audible sound wave frequency band, through identical hardware (e.g., a decoding apparatus) while minimizing mutual interference. A user receives more various human machine interface (HMI) through the combination of the voice and the sound code.

The operation performance unit 11 may perform the operation based on the control information. If the control information is control information to make the power of the device 10 on/off, the operation performance unit 11 may make the power of the device (e.g., a refrigerator, a washing machine, an air conditioner, a cleaner and so on) on/off. As another example, if the control information is control information to move the device 10, the operation performance unit 11 may move the device 10.

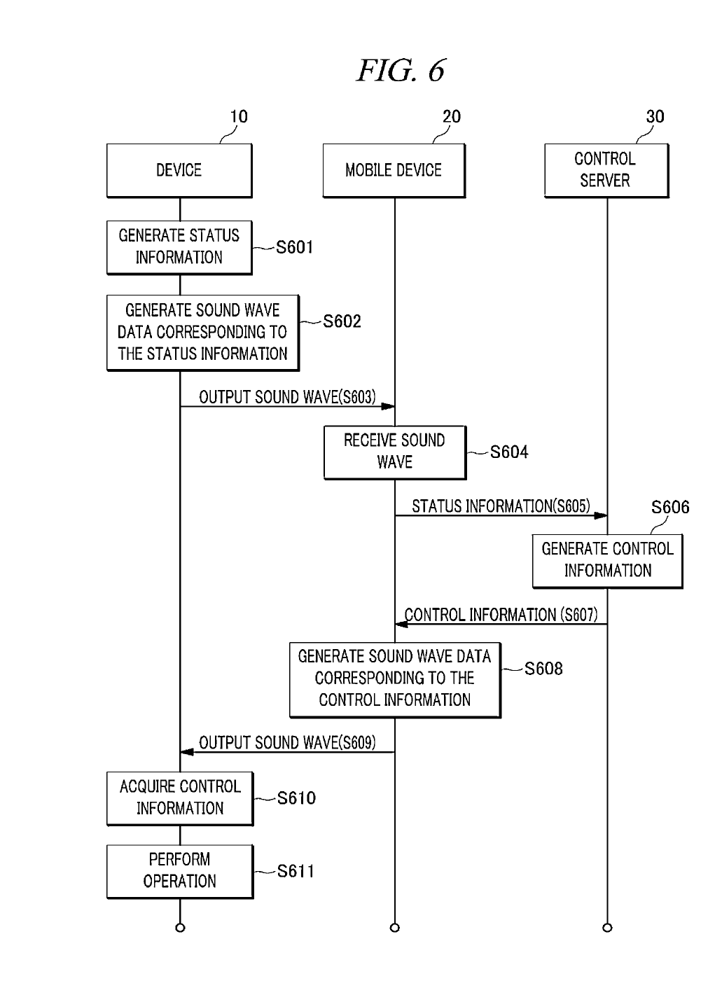

FIG. 6 is an operation flow chart showing an example for operation of the device 10, the mobile device 20 and the control server 30. To described an example with reference to FIG. 6, the device 10 generates status information associated with the operation of the device 10 (S601), and generates sound wave data corresponding to the generated status information (S602). When the device 10 outputs a sound wave corresponding to the sound wave data through a sound wave output device (S603), the mobile device 20 receives the sound wave output from the device 10, and acquires status information from the received sound wave (S604).

When the mobile device 20 transmits the status information of the device 10 to the control server 30 (S605), the control server 30 generates control information corresponding to the status information (S606) to transmit the control information to the mobile device 20 (S607).

When the mobile device 20 generates sound wave data corresponding to the received control information (S608), and outputs a sound wave corresponding to the sound wave data through a sound wave output device (S609), the device 10 receives the sound wave output from the mobile device 20 to acquire control information from the received sound wave (S610), and performs operation corresponding to the acquired control information (S611). In the descriptions above, S601 to S611 may be divided into additional steps or combined with one another to be a narrower scope of steps in accordance with example embodiments. In addition, parts of the steps may be omitted according to necessity, and the sequence of the steps may be changed.

As illustrated in FIG. 2, the device 10 may further include a position information generation unit 18.

The position information generation unit 18 generates position information of the mobile device 20 by using a multiple number of sound wave reception devices. In this case, the operation performance unit 11 performs operation based on the position information.

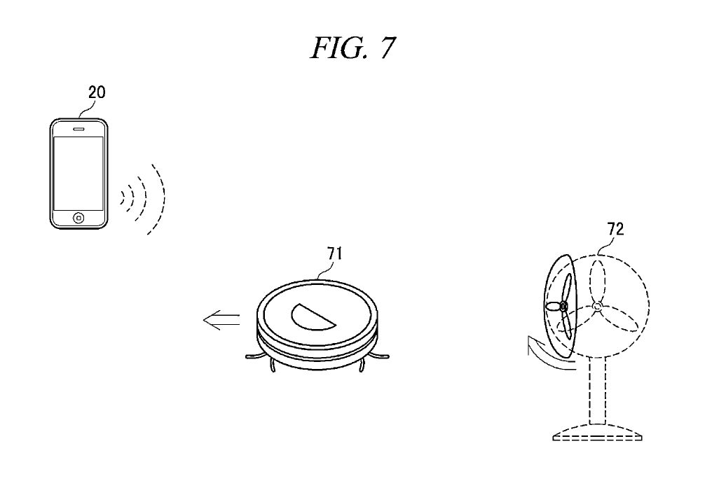

FIG. 7 depicts an example for operation of the operation performance unit 11. To describe an example with reference to FIG. 7, if the device 10 is a cleaner 71, the operation performance unit 11 may perform or control operation of the cleaner 71 based on position information of the mobile device 20 such that the cleaner 71 is moved toward the mobile device 20. As another example, if the device 10 is an electric fan 72, the operation performance unit 11 may perform or control operation of the electric fan 72 such that the rotation direction of the electric fan 72 is directed toward the mobile device 20.

The position information generation unit 18 may generate position information based on a difference of times when the received sound wave is input into each of the multiple number of the sound wave reception devices. In this case, the position information may be an azimuth between at least one of the multiple number of the sound wave reception devices and the device 10, and the mobile device 20.

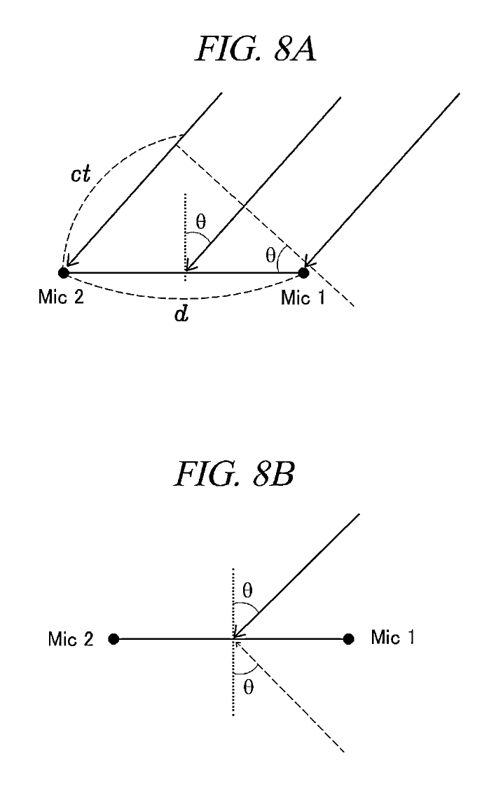

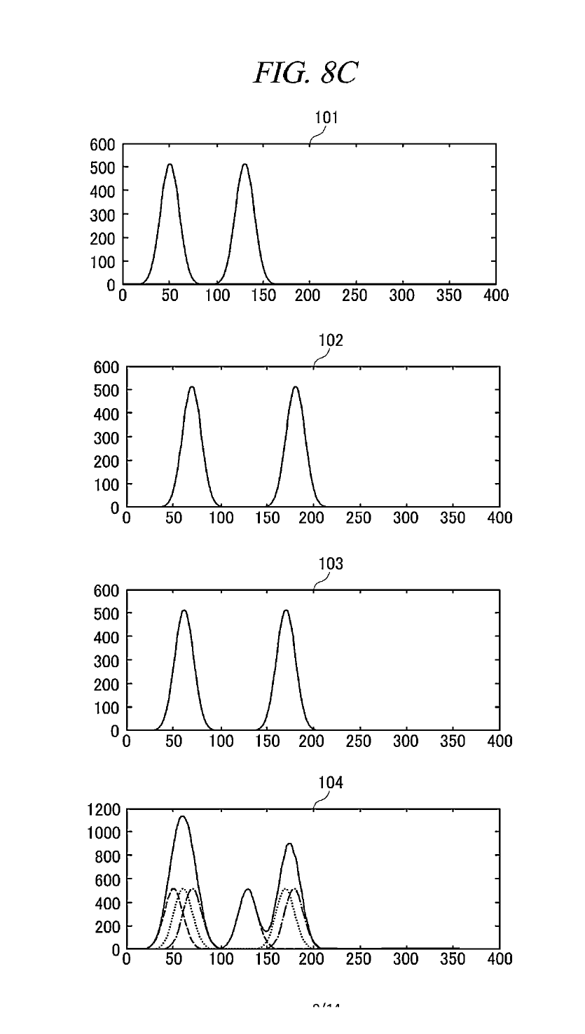

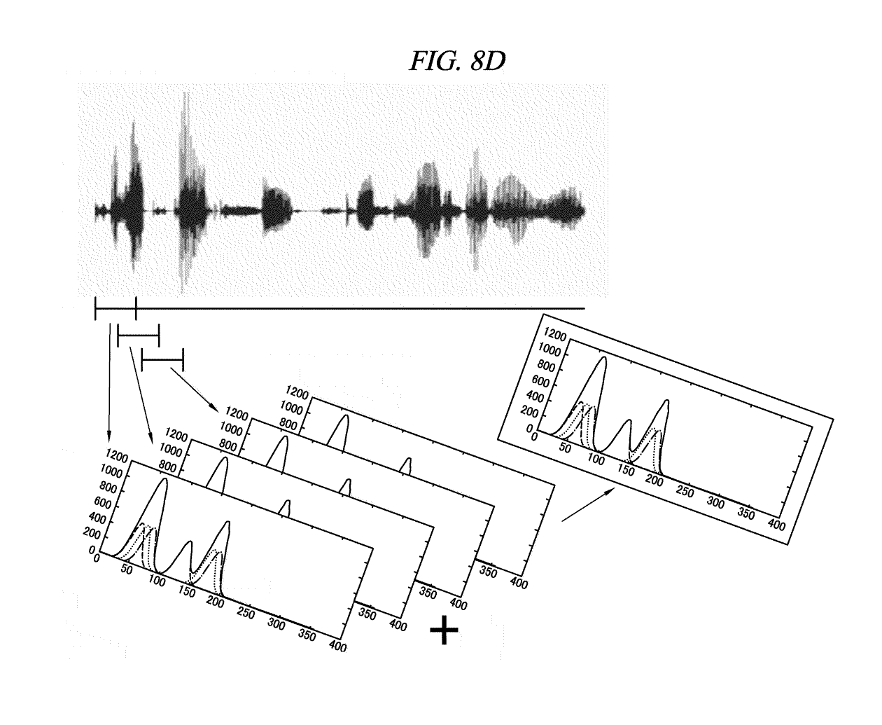

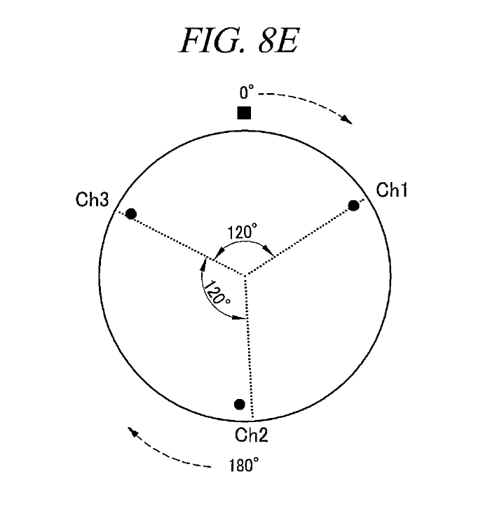

FIG. 8a to FIG. 8e depict an example for operation of the position information generation unit 18. Hereinafter, an example for operation of the position information generation unit 18 is described with reference to FIG. 8a to FIG. 8e.

The device 10 performs operation toward the position of the mobile device 20 depending on change in the position or the position information of the mobile device 20. For example, in case of an air conditioner or an electric fan, it is possible to move a direction of wind toward a direction of a user based on identification of the position of the mobile device 20, and in case of a cleaner, it is possible to set a cleaning direction to be toward a user's desired direction. To this end, the position information generation unit 18 generates position information of the mobile device 20.

The position information generation unit 18 detects the sound wave output from the mobile device 20, and if the detected sound wave is determined to be control information, the position information generation unit 18 determines the detected sound wave to be a sound wave, for which position information should be generated. Thereafter, the position information generation unit 18 overlaps each of the multiple number of the frames. For example, if each frame includes 1024 samples, the position information generation unit 18 may overlap 512 samples with the other 512 samples.

The position information generation unit 18 estimates a time difference of times when a sound wave (or a sound code) is input into each of the multiple number of the sound wave reception devices. This may be referred-to as estimation of an inter-aural time difference (ITD).

The position information generation unit 18 traces a position of a sound source, for example, based on a time difference among three (3) sound wave reception devices (e.g., microphones), and if cross correlation calculated in a time domain is applied to a frequency domain, a calculation amount and calculation time can be significantly reduced, and the same outcome can be obtained. In order to obtain the time difference among the three (3) sound wave reception devices through Math Formula 1, the position information generation unit 18 creates a pair (or a channel) of first and second microphones, a pair (or a channel) of second and third microphones, and a pair (or a channel) of third and first microphones, and calculates cross correlation among the pairs.

y(d)=IDFT{DFT*{x₁(n)}DFT{x₂(n)}}

estimated delay=arg max{y(d)} [Math Formula 1]

In this case, d means delay values between two sound waves, y(d) means a function presenting delay values between two sound waves, * means a complex conjugate, x1(n) means a sound wave input into the first microphone, and x2(n) means a sound wave input into the second microphone. In addition, an index value d of y(d), which has the highest value of the calculated values y(d), is regulated as a time difference (estimated delay) between two signals, and total three (3) values for a time difference corresponding to the three (3) pairs can be obtained.

The position information generation unit 18 performs azimuth mapping based on the time difference. First, with reference to FIG. 8A, the position information generation unit 18 calculates an incident angle of a sound wave based on a velocity of the sound wave and a time difference between two microphones through Math Formula 2.

$$sin θ = \frac{ct}{d} \\ θ = arcsin ( \frac{c \cdot delay samples \cdot sampling period}{d} ) \qquad [ Math Formul a 2 ]$$

In this case, θ may mean an incident angle of the sound wave, c may mean a velocity of the sound wave, t may mean a time difference between the microphones, and d may mean a distance between the two microphones. The time difference means the estimated time difference obtained in S902, and since such a time difference indicates a difference in the number of samples, it may be represented in the form of multiplication of a sampling period and delay samples.

With reference to FIG. 8B, while there is one time difference between the two microphones, two (2) azimuths are obtained through azimuth transformation. This is because incident angles having an identical time difference are symmetrically present based on the line connecting the two (2) microphones. Thus, an azimuth of the sound wave estimated for the three pairs of microphone have total six (6) candidates. The six (6) candidate azimuths are elected as the most reliable azimuth candidates of a specific frame.

With reference to FIG. 8C, the position information generation unit 18 may generate an azimuth-Gaussian histogram. Specifically, if three (3) estimated delay values are delay 1, delay 2 and delay 3, the position information generation unit 18 calculates two (2) azimuths by each of the delay values, and calculates total six (6) candidate azimuths, i.e., azim 11, azim 12, azim 21, azim 22, azim 31 and azim 32.

The position information generation unit 18 generates a histogram 101 by using azim 11 and azim 12, a histogram 102 by using azim 21 and azim 22, and a histogram 103 by using azim 31 and azim 32. In this case, in azim ij, i means each channel (or a microphone), and j means an identification number of each of the two (2) estimated azimuths. In addition, the position information generation unit 18 generates each of the histograms by using a Gaussian function, in which the two (2) candidate azimuths of each of the pairs are mean. In addition, θ refers to a circular index, and a circular index of 360 or more starts from 0 again.

The position information generation unit 18 makes the three (3) histograms and accumulates all the histograms to generate an accumulated Gaussian histogram 104.

With reference to FIG. 8D, the position information generation unit 18 estimates six (6) candidate azimuths by each frame, and selects an azimuth having the highest frequency from the candidate azimuths of the whole frames as a final azimuth. To this end, the position information generation unit 18 may compare the accumulated Gaussian histograms by the frames with one another. In general, it is difficult to obtain a reliable azimuth only from calculation of one or two frames, due to an energy size or an effect of reverberation. In this case, it is preferable to determine an azimuth having the highest frequency value among the estimated candidate azimuths to be a final azimuth by inspecting all the frames with the same method. In addition, if the Gaussian histogram obtained by accumulating the three (3) pairs in one frame is accumulated once more over the multiple frames, the most estimated angle value can be obtained.

The position information generation unit 18 generates the final azimuth as position information. In this case, with reference to FIG. 8E, the position information generation unit 18 may increase the azimuth from 0°, which is the center point of the microphones 1 and 3, in the clockwise direction, after assuming that the mobile device 20 is sufficiently far away, and the sound wave is incident in a plane wave form.

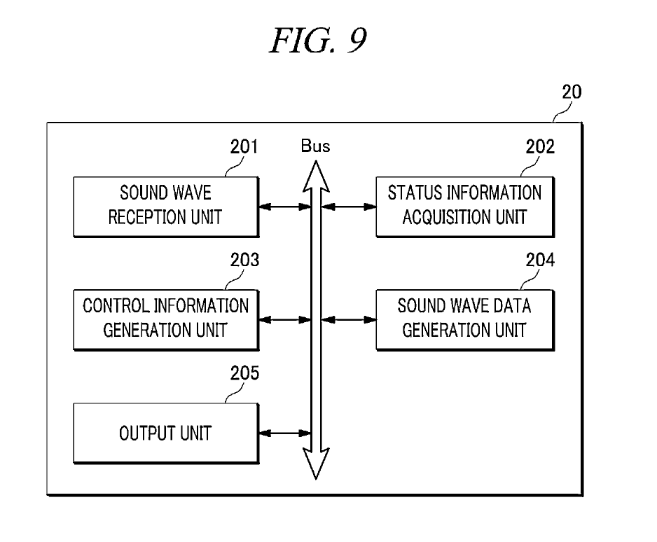

FIG. 9 is a configuration view of the mobile device 20 in accordance with an example embodiment. With reference to FIG. 9, the mobile device 20 includes a sound wave reception unit 201, a status information acquisition unit 202, a control information generation unit 203, a sound wave data generation unit 204 and an output unit 205. However, the mobile device 20 illustrated in FIG. 9 is merely an example embodiment of the present disclosure, and various modifications based on the components illustrated in FIG. 9 are possible. For example, the mobile device 20 may further include at least one of user interface that receives information from a user, a display, a sound wave output device and a sound wave reception device.

The sound wave reception unit 201 receives a sound wave output from the device 10 through a sound wave reception device. An example for the sound wave reception device is a microphone, but not limited thereto.

The status information acquisition unit 202 acquires status information of the device 10 by using the sound wave.

The status information acquisition unit 202 may divide the sound wave into a multiple number of frames depending on a preset time interval, identify a frequency corresponding to each of the multiple number of the frames through frequency analysis for each of the multiple number of the frames, and generate status information corresponding to the received sound wave based on the multiple number of the partial information corresponding to the identified frequencies.

The operation of the status information acquisition unit 202 is mostly identical or similar to the operation of the aforementioned control information acquisition unit 17, but different therefrom only in that the received sound wave and the control information in the operation of the control information acquisition unit 17 are expressed as a sound wave and status information in the status information acquisition unit 202, respectively. Thus, instead of parts of the descriptions of the status information acquisition unit 202, which are omitted hereinafter, the descriptions of the control information acquisition unit 17 will be referenced.

The status information acquisition unit 202 in accordance with an example embodiment includes a frame division unit (not illustrated), a frequency identification unit (not illustrated) and a status information generation unit (not illustrated). In this case, most of the operation of the frame division unit (not illustrated), the operation of the frequency identification unit (not illustrated) and the operation of the status information generation unit (not illustrated) are identical or highly similar to the operation of the frame division unit 171, the operation of the frequency identification unit 172 and the operation of the control information generation unit 173, respectively. As described above, the operations are different from each other only in that the received sound wave and the control information are expressed as a sound wave and status information, respectively. Thus, instead of parts of the descriptions of the frame division unit (not illustrated), the frequency identification unit (not illustrated) and the status information generation unit (not illustrated) of the status information acquisition unit 202, which are omitted hereinafter, the descriptions of the frame division unit 171, the frequency identification unit 172, and the control information generation unit 173 will be referenced.

The control information generation unit 203 generates control information for the device 10 based on the status information. In this case, the control information generation unit 203 may transmit the status information to the control server 30 through a network, and receive control information from the control server 30.

As described above, an example for the control information includes control information to make the power of the device 10 on/off, control information to move the device 10, control information to rotate the device (10) and others.

The sound wave data generation unit 204 generates sound wave data corresponding to the control information. The sound wave data generation unit 204 generates a multiple number of partial information corresponding to the control information, determines at least one frequency band, which corresponds to each of the multiple number of the generated partial information, from an audible sound wave frequency band and a non-audible sound wave frequency band, determines at least one frequency corresponding to each of the multiple number of the partial information within the determined frequency band, generates a sound signal corresponding to the determined frequency for each of the generated partial information, and combines the sound signals with one another to generate sound wave data corresponding to the control information.

Specifically, the sound wave data generation unit 204 may generate sound wave data corresponding to the control information, by generating a multiple number of partial information corresponding to the control information, determining a multiple number of frequencies corresponding to the multiple number of the generated partial information, and combining sound signals corresponding to the multiple number of the respective determined frequencies with one another depending on a preset time interval.

Most of the operation of the sound wave data generation unit 204 is identical or highly similar to the above-described operation of the sound wave data generation unit 13, but different therefrom only in that the status information is expressed as control information. Thus, instead of parts of the descriptions of the sound wave data generation unit 204, which are omitted hereinafter, the descriptions of the sound wave data generation unit 13 will be referenced.

The sound wave data generation unit 204 in accordance with an example embodiment includes a partial information generation unit (not illustrated), a frequency determination unit (not illustrated), a sound signal generation unit (not illustrated) and a generation unit (not illustrated). In this case, most of the operation of the partial information generation unit (not illustrated), the operation of the frequency determination unit (not illustrated), the operation of the sound signal generation unit (not illustrated) and the operation of the generation unit (not illustrated) are identical or highly similar to the operation of the partial information generation unit 131, the operation of the frequency determination unit 132, the sound signal generation unit 133 and the operation of the generation unit 134, respectively. As described above, the operations are different from each other only in that the status information is expressed as control information. Thus, instead of parts of the descriptions of the partial information generation unit (not illustrated), the frequency determination unit (not illustrated), the sound signal generation unit (not illustrated) and the generation unit (not illustrated), which are omitted hereinafter, the descriptions of the partial information generation unit 131, the frequency determination unit 132, the sound signal generation unit 133 and the generation unit 134 will be reference.

The output unit 205 outputs control information. In this case, the output unit 205 may output the control information in a sound wave form. For example, the output unit 205 outputs a sound wave corresponding to the generated sound wave data through a sound wave output device.

Meanwhile, a method for controlling a device in accordance with an example embodiment is described below, and the descriptions of the device 10 provided above with reference to FIG. 1 to FIG. 9 may be applied.

The device 10 receives the sound wave output from the mobile device 20 through a sound wave reception unit.

Subsequently, the device 10 acquires control information associated with the operation of the device 10 from the received sound wave.

In this case, partial information is determined based on a frequency band, to which at least one frequency identified from a certain frame within the received sound wave corresponds, from an audible sound wave frequency band and a non-audible sound wave frequency band, and the at least one identified frequency. In addition, control information corresponding to the received sound wave is acquired based on each of the determined partial information.

Next, the device 10 performs the operation of the device 10 based on the control information.

In addition, according to a method for controlling a device in accordance with another example, the device 10 generates status information of the device 10 associated with the operation of the device 10.

Thereafter, the device 10 generates sound wave data corresponding to the status information, and outputs a sound wave corresponding to the generated sound wave data through a sound wave output device. The mobile device 20 generates control information based on status information within the output sound wave, and re-outputs a sound wave including the control information.

Subsequently, the device 10 receives the sound wave output from the mobile device 20 through a sound wave reception device, and performs each step according to the method for controlling a device in accordance with an example embodiment.

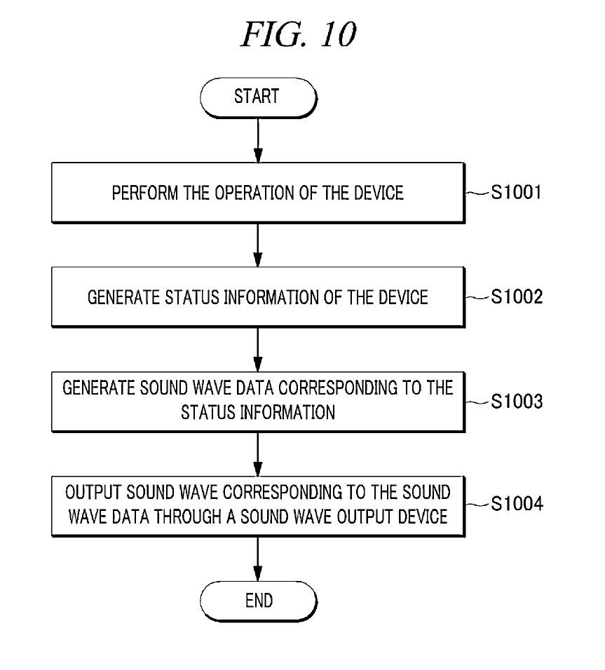

FIG. 10 is an operation flow chart showing a method for outputting a sound wave in accordance with an example embodiment. The method for outputting a sound wave as illustrated in FIG. 10 includes the steps sequentially performed in the device 10. Accordingly, the descriptions of the device 10 provided above with reference to FIG. 1 to FIG. 9 are also applied to FIG. 10, even though the descriptions are omitted hereinafter.

In S1001, the operation performance unit 11 performs the operation of the device 10. In S1002, the status information generation unit 12 generates status information of the device 10 associated with the operation. In S1003, the sound wave data generation unit 13 generates sound wave data corresponding to the status information. In S1004, the sound wave output unit 14 outputs a sound wave corresponding to the generated sound wave data through a sound wave output device.

Although not illustrated in FIG. 10, the method for outputting a sound wave in accordance with an example embodiment may further include receiving the sound wave output from the mobile device 20 through a sound wave reception device, and acquiring control information by using the received sound wave. In this case, the operation performance unit 11 may perform the operation of the device 10 based on the control information.

Although not illustrated in FIG. 10, the method for outputting a sound wave in accordance with an example embodiment may further include determining the state of the device 10 (not illustrated). In this case, in S1002, the status information generation unit 12 generates status information of the device 10 depending on the result of the determination.

In the descriptions above, S1001 to S1004 may be further divided into additional steps or combined with one another to be a narrower scope of steps, according to example embodiments. In addition, parts of the steps may be omitted according to necessity, and the sequence of the steps may be changed.

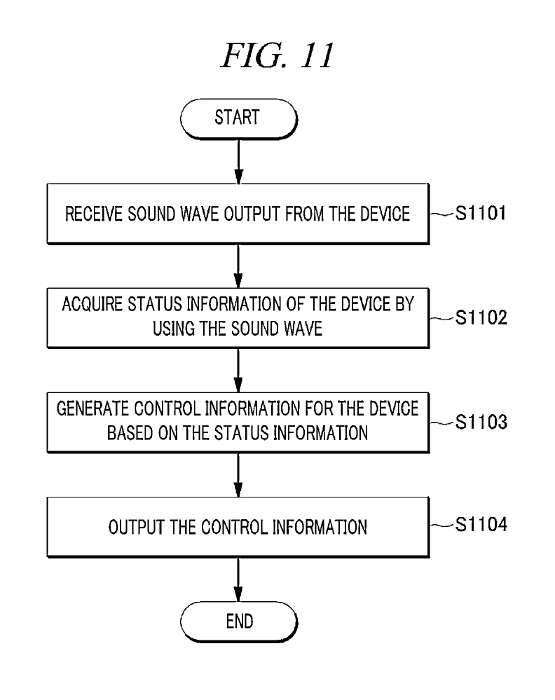

FIG. 11 is an operation flow chart showing a method for outputting control information in accordance with an example embodiment. The method for outputting control information as illustrated in FIG. 11 includes the steps sequentially performed in the mobile device 20. Accordingly, the descriptions of the mobile device 20 provided above with reference to FIG. 1 to FIG. 9 are also applied to FIG. 11, even though the descriptions are omitted hereinafter.

In S1101, the sound wave reception unit 201 receives the sound wave output from the device 10 through a sound wave reception device. In S1102, the status information acquisition unit 202 acquires status information of the device 10 by using the sound wave. In S1103, the control information generation unit 203 generates control information for the device 10 based on the status information. In S1104, the output unit 205 outputs the generated control information.

Although not illustrated in FIG. 11, the method for outputting control information in accordance with an example embodiment may further include generating sound wave data corresponding to the control information, between S1103 and S1104. In this case, in S1105, the output unit 205 outputs a sound wave corresponding to the generated sound wave data.

In the descriptions above, S1101 to S1104 may be further divided into additional steps or combined with one another to be a narrower scope of steps, according to example embodiments. In addition, parts of the steps may be omitted according to necessity, and the sequence of the steps may be changed.

The sound wave outputting method described by using FIG. 10 and the control information outputting method described by using FIG. 11 can be embodied in a storage medium including instruction codes executable by a computer or processor such as a program module executed by the computer or processor. A computer readable medium can be any usable medium which can be accessed by the computer and includes all volatile/nonvolatile and removable/non-removable media. Further, the computer readable medium may 0include all computer storage and communication media. The computer storage medium includes all volatile/nonvolatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes information transmission mediums.

The above description of the example embodiments is provided for the purpose of illustration, and it would be understood by those skilled in the art that various changes and modifications may be made without changing technical conception and essential features of the example embodiments. Thus, it is clear that the above-described example embodiments are illustrative in all aspects and do not limit the present disclosure. For example, each component described to be of a single type can be implemented in a distributed manner. Likewise, components described to be distributed can be implemented in a combined manner.

The scope of the inventive concept is defined by the following claims and their equivalents rather than by the detailed description of the example embodiments. It shall be understood that all modifications and embodiments conceived from the meaning and scope of the claims and their equivalents are included in the scope of the inventive concept.

We claim:

1. A device comprising:
a sound wave reception unit that receives a sound wave output from a mobile device, through a sound wave reception device;
a control information acquisition unit that acquires control information associated with operation of the device from the received sound wave; and
an operation performance unit that performs the operation based on the control information,
wherein the control information acquisition unit determines a frequency band, to which at least one frequency identified from a certain frame within the received sound wave corresponds, from an audible sound wave frequency band and a non-audible sound wave frequency band, and partial information based on the frequency band and the at least one identified frequency, and
acquires control information corresponding to the received sound wave based on each of the determined partial information.

2. The device of claim 1, further comprising
a status information generation unit that generates status information of the device in association with the operation;
a sound wave data generation unit that generates sound wave data corresponding to the status information; and
a sound wave output unit that outputs a sound wave corresponding to the generated sound wave data through a sound wave output device,
wherein the control information is generated in the mobile device based on the status information.

3. The device of claim 1,
wherein the operation performance unit performs the operation through at least one power device included in the device.

4. The device of claim 2,
wherein the status information includes at least one of current status or breakdown diagnosis information of the device.

5. The device of claim 2,
wherein the received sound wave includes a response to the sound wave output from the sound wave output unit.

6. The device of claim 2, further comprising
a status determination unit that determines the status of the device,
wherein the status information generation unit generates status information of the device depending on the result of the determination.

7. The device of claim 2,
wherein the sound wave data generation unit comprises:
a partial information generation unit that generates a plurality of partial information corresponding to status information;
a frequency determination unit that determines a frequency corresponding to each of the plurality of the partial information;
a sound signal generation unit that generates a plurality of sound signals corresponding to the multiple number of the frequencies, respectively; and
a generation unit that generates the sound wave data corresponding to the status information by combining the plurality of the sound signals with one another depending on a predetermined time interval.

8. The device of claim 1,
wherein the control information acquisition unit comprises:
a frame division unit that divides the received sound wave into a plurality of frames depending on a predetermined time interval;
a frequency identification unit that identifies at least one frequency corresponding to each of the plurality of the frames by analyzing a frequency for each of the plurality of the frames; and
a control information generation unit that determines a plurality of partial information based on a frequency band, to which each of the identified frequencies corresponds, and each of the identified frequencies, and generates control information corresponding to the received sound wave based on each of the determined partial information.

9. The device of claim 1, further comprising
a position information generation unit that generates position information of the mobile device by using a plurality of sound wave reception devices,
wherein the operation performance unit performs the operation toward a position of the mobile device based on the position information.

10. The device of claim 9,
wherein the position information generation unit generates the position information based on a difference of times when the sound wave output from the mobile device is input into each of the plurality of the sound wave reception devices.

11. The device of claim 1,
wherein the received sound wave includes ID of the device, and
the control information acquisition unit acquires the control information after authenticating the received sound wave by using the ID.

12. The device of claim 1,
wherein the control information acquisition unit comprises a control information generation unit that generates first control information corresponding to the received sound wave and recognizes voice of a user received through the sound wave reception device to generate second control information corresponding to the voice, and
the operation performance unit performs the operation based on the first and second control information.

13. A method for controlling a device, comprising:
receiving a sound wave output from a mobile device through a sound wave reception device;
acquiring control information associated with operation of the device from the received sound wave; and
performing the operation based on the control information,
wherein the acquiring of the control information comprises:
determining a frequency band, to which at least one frequency identified from a certain frame within the received sound wave corresponds, from an audible sound wave frequency band and a non-audible sound wave frequency band, and partial information based on the frequency band and the at least one identified frequency; and
acquiring control information corresponding to the received sound wave based on each of the determined partial information.

14. The method for controlling a device of claim 13, further comprising:
generating status information of the device in association with the operation;
generating sound wave data corresponding to the status information; and
outputting a sound wave corresponding to the generated sound wave data through a sound wave output device,
wherein the control information is generated in the mobile device based on the status information.

15. The device of claim 13, further comprising
determining the status of the device
wherein the generating of the status information generates status information of the device depending on the result of the determination.

16. A mobile device, comprising:
a sound wave reception unit that receives a sound wave output from a device, through a sound wave reception device;
a status information acquisition unit that acquires status information of the device by using the sound wave;
a control information generation unit that generates control information for the device based on the status information;
a sound wave data generation unit that generates sound wave data corresponding to the control information; and
an output unit that outputs a sound wave corresponding to the generated sound wave data through a sound wave output device,
wherein the sound wave data generation unit
generates a plurality of partial information corresponding to the control information,
determines a frequency band, which corresponds to each of the plurality of the partial information, from an audible sound wave frequency band and a non-audible sound wave frequency band,
determines at least one frequency corresponding to each of the plurality of the partial information within the determined frequency band,
generates a sound signal corresponding to the determined frequency for each of the plurality of the partial information, and
generates the sound wave data by combining the sound signals with one another.

17. The mobile device of claim 16,
wherein the control information generation unit transmits the status information to a control server through a network, and receives the control information from the control server.
